(19) United States
(12) Patent Application Publication
(10) Pub. No.: US 2014/0293861 A1
(43) Pub. Date: Oct. 2, 2014

(54) APPARATUS FOR TRANSMITTING/RECEIVING MULTICAST DATA IN WIRELESS COMMUNICATION SYSTEM AND METHOD THEREOF

(71) Applicants: Jeongki Kim, Anyang-si (KR); Jinsam Kwak, Anyang-si (KR); Youngsoo Yuk, Anyang-si (KR)

(72) Inventors: Jeongki Kim, Anyang-si (KR); Jinsam Kwak, Anyang-si (KR); Youngsoo Yuk, Anyang-si (KR)

(73) Assignee: LG ELECTRONICS INC., Seoul (KR)

(21) Appl. No.: 14/238,425

(22) PCT Filed: Aug. 10, 2012
(86) PCT No.: PCT/KR2012/006385

§ 371 Date: Apr. 17, 2014

Related U.S. Application Data
(60) Provisional application No. 61/522,675, filed on Aug. 11, 2011.
(60) Provisional application No. 61/536,083, filed on Sep. 19, 2011.
(60) Provisional application No. 61/548,707, filed on Oct. 18, 2011.
(60) Provisional application No. 61/554,985, filed on Nov. 3, 2011.

(30) Foreign Application Priority Data
Mar. 30, 2012 (KR) 10-2012-0033481

(51) Int. Cl. H04W 4/06; H04W 4/00; H04L 12/18

(52) U.S. Cl. CPC H04W 4/06; H04L 12/189; H04W 4/005
USPC 370/312

(57) ABSTRACT

An apparatus for transmitting/receiving multicast data in a wireless communication system and method thereof are disclosed. The present invention includes receiving information including an M2M group identifier (MGID) assigned to an M2M (machine-to-machine) device from a base station, receiving a message related to M2M multicast assignment having the MGID information applied thereto from the base station, and receiving the multicast data from the base station in accordance with instruction of the message from the base station, wherein the multicast data comprises a flow identifier (FID) field in a MAC header of a MAC PDU (medium access control packet data unit) for a multicast service flow and wherein the FID field is set to a specific value.

### TECHNICAL FIELD

The present invention relates to a wireless communication, and more particularly, to an apparatus for transmitting/receiving multicast data in a wireless communication system and method thereof.

### BACKGROUND ART

Generally, a machine-to-machine (hereinafter abbreviated M2M) communication literally means a communication between one electronic device and another electronic device. In a broad sense, the M2M communication may mean a wire/wireless communication between electronic devices or a communication between a human-controllable device and a machine. Recently, the M2M communication may generally indicate a communication between electronic devices, i.e., a device-to-device wireless communication performed without human involvement.

In the early 1990's, in which the concept of the M2M communication has been initially introduced, the M2M communication has been recognized as remote control or telematics or the like and derivative markets of the M2M communication were very limitative. Yet, the M2M communication has grown rapidly for past few years and has become the globally noteworthy markets. Specifically, in POS (point of sales) and security related application markets, the M2M communication has considerably influence on such field as fleet management, remote monitoring of machinery and equipment, smart meter for auto-measurement of operating time, consumed heat or electricity quantity on construction machinery equipment and the like. M2M communication in the future will be further utilized for various usages in connection with a small-scale output communication solution such as conventional mobile communication, wireless high-speed interne, Wi-Fi, ZigBee and the like and may lay the foundation of expansion to B2C (business to consumer) markets instead of being confined to B2B (business to business) markets.

In the era of the M2M communication, every machine equipped with SIM (subscriber identify module) card enables data transmission and reception and is capable of remote management and control. For instance, as M2M communication technology is usable for numerous devices and equipment including vehicles, trucks, containers, auto-vending machines, gas tanks and the like, its application fields may reach far and wide.

According to a related art, since mobile stations are managed by individual unit in general, a communication between a base station and a mobile station is usually performed by a one-to-one communication scheme. Assuming that numerous M2M devices communicate with a base station by the one-to-one communication scheme, network may be overloaded due to the occurrence of signaling between the base station and each of the numerous M2M devices. As mentioned in the above description, in case that the M2M communications are rapidly spreading across a wider scope, overheads due to the communications between the M2M devices or the communications between the base station and the M2M devices may cause problems.

According to the properties of the M2M devices, if an event of the like occurs, most of the M2M devices in idle mode awake from the idle mode. Moreover, in order to receive multicast data, the M2M device in the idle mode may awake in a prescribed interval.

However, a method for an M2M device to efficiently receive multicast data or a method for a base station to efficiently transmit multicast data to an M2M device has not been proposed in detail yet.

### DISCLOSURE OF INVENTION

### Technical Problem

Accordingly, the present invention is directed to an apparatus for transmitting/receiving multicast data in a wireless communication system and method thereof that substantially obviate one or more of the problems due to limitations and disadvantages of the related art.

One object of the present invention is to provide a method for an M2M (machine-to-machine) device to receive multicast data in a wireless communication system.

Another object of the present invention is to provide a method for a base station to transmit multicast data in a wireless communication system.

Another object of the present invention is to provide an M2M (machine-to-machine) device capable of receiving multicast data in a wireless communication system.

A further object of the present invention is to provide a base station capable of transmitting multicast data in a wireless communication system.

Technical tasks obtainable from the present invention are non-limited the above-mentioned technical task. And, other unmentioned technical tasks can be clearly understood from the following description by those having ordinary skill in the technical field to which the present invention pertains.

### Solution to Problem

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a method of receiving multicast data by an M2M (machine-to-machine) device in a wireless communication system, according to one embodiment of the present invention may include the steps of receiving information including an M2M group identifier (MGID) assigned to the M2M device from a base station, receiving a message related to M2M multicast assignment including the MGID from the base station, and receiving the multicast data based on the message from the base station, wherein the multicast data comprises a flow identifier (FID) field in a MAC header of a MAC PDU (medium access control packet data unit) for a multicast service flow and wherein the FID field is set to a specific value.

Preferably, the specific value set for the FID field may be set to either 0b0100 or 0100.

Preferably, the message is a M2M multicast assignment A-MAP IE (Information Element) message.

More preferably, the MGID may be transmitted through the M2M multicast assignment A-MAP IE by a manner that the MGID is CRC (cyclic redundancy check) masked.

To further achieve these and other advantages and in accordance with the purpose of the present invention, a method of transmitting multicast data by a base station in a wireless communication system, according to another embodiment of the present invention may include the steps of transmitting information including an M2M group identifier (MGID) assigned to an M2M (machine-to-machine) device, sending a message related to M2M multicast assignment including the MGID to the M2M device, and transmitting the multicast data to the M2M device based on the message, wherein the multicast data comprises a flow identifier (FID) field in a MAC header of a MAC PDU (medium access control packet data unit) for a multicast service flow and wherein the FID field is set to a specific value.

Preferably, the specific value set for the FID field may be set to either 0b0100 or 0100.

To further achieve these and other advantages and in accordance with the purpose of the present invention, an M2M (machine-to-machine) device for receiving multicast data in a wireless communication system, according to another embodiment of the present invention may include a receiver configured to receive information including an M2M group identifier (MGID) assigned to the M2M device, a message related to M2M multicast assignment including the MGID, and downlink data based on the message from a base station and a processor, if the downlink data comprises a flow identifier (FID) field in a MAC header of a MAC PDU (medium access control packet data unit) for a multicast service flow and the FID field is set to a specific value, determining whether the received downlink data is the multicast data.

Preferably, the specific value set for the FID field may be set to one of 0b0100 and 0100.

Preferably, the message may include a type of M2M multicast assignment A-MAP IE.

To further achieve these and other advantages and in accordance with the purpose of the present invention, a base station for transmitting multicast data in a wireless communication system, according to a further embodiment of the present invention may include a transmitter configured to transmit information including an M2M group identifier (MGID) assigned to an M2M (machine-to-machine) device, a message related to M2M multicast assignment including the MGID information applied thereto, and the multicast data based on the message to the M2M device, wherein the multicast data comprises a flow identifier (FID) field in a MAC header of a MAC PDU (medium access control packet data unit) for a multicast service flow and wherein the FID field is set to a specific value.

Preferably, the specific value set for the FID field may be set to either 0b0100 or 0100.

It is to be understood that both the foregoing general description and the following detailed description are exemplary and explanatory and are intended to provide further explanation of the invention as claimed.

### Advantageous Effects of Invention

According to various embodiments of the present invention, a base station efficiently transmits multicast data to M2M devices, whereby communication performance in viewpoint of the M2M devices is enhanced.

Effects obtainable from the present invention may be non-limited by the above mentioned effect. And, other unmentioned effects can be clearly understood from the following description by those having ordinary skill in the technical field to which the present invention pertains.

### BRIEF DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic diagram for configurations of an M2M device and a base station according to one embodiment of the present invention; and

FIG. 2 is a flowchart for one example of a process for assigning MGID (M2M group ID) and CID to an M2M device from a base station according to one embodiment of the present invention.

### BEST MODE FOR CARRYING OUT THE INVENTION

Reference will now be made in detail to the preferred embodiments of the present invention, examples of which are illustrated in the accompanying drawings. In the following detailed description of the invention includes details to help the full understanding of the present invention. Yet, it is apparent to those skilled in the art that the present invention can be implemented without these details. Detailed description disclosed together with the accompanying drawings is intended to explain not a unique embodiment of the present invention but an exemplary embodiment of the present invention. For instance, although the following descriptions are made in detail on the assumption that a mobile communication system includes IEEE (institute of electrical and electronics engineers) 802.16 system or 3GPP (3rd generation partnership project) system, they are applicable to other random mobile communication systems except unique features of IEEE 802.16 system or 3GPP system.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Besides, in the following description, assume that a terminal is a common name of such a mobile or fixed user stage device as a user equipment (UE), a mobile station (MS), an advanced mobile station (AMS), a machine-to-machine (M2M) device and the like. And, assume that a base station is a common name of such a random node of a network stage communicating with a terminal as a Node B, an eNode B, a base station (BS), an access point (AP) and the like.

In a mobile communication system, a mobile station may be able to receive information in downlink from a base station and transmit information in uplink to the base station. The information transmitted or received by the mobile station may include data and various control information. And, various kinds of physical channels may exist in accordance with types and usages of the information transmitted or received by the mobile station.

First of all, embodiments of the present invention are usable for various radio access systems including CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented by such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc. UTRA is a part of UMTS (Universal Mobile Telecommunications System). 3GPP (3rd Generation Partnership Project) LTE (long term evolution) is a part of E-UMTS (Evolved UMTS) that uses E-UTRA. The 3GPP LTE adopts OFDMA in DL and SC-FDMA in UL. And, LTE-A (LTE-Advanced) is an evolved version of 3GPP LTE.

In the following description, an M2M communication may mean information exchange performed between mobile stations or between a base station and each of mobile stations without human involvement. Hence, the M2M device may mean a mobile station capable of supporting the above-mentioned M2M device communication. An access service network for an M2M service may be defined as an M2M ASN (M2M access service network) and a network entity performing communications with M2M devices may be named an M2M server. In particular, the M2M server activates an M2M application and provides an M2M-specific service for at least one or more M2M devices. An M2M feature indicates a feature of an M2M application. And, at least one feature may be necessary to provide an application. An M2M device group may mean a group of M2M devices that share at least one common feature with each other.

The devices performing communications by M2M scheme may be variously named M2M devices, M2M communication devices, MTC (machine type communication) devices and the like. And, the number of the devices will increase gradually as the number of machine application types does. The currently discussed machine application types may include (1) security, (2) public safety, (3) tracking and tracing, (4) payment, (5) healthcare, (6) remote maintenance and control, (7) metering, (8) consumer device, (9) POS (Point Of Sales) and fleet Management in security related market, (10) M2M communication of vending machine (11) smart meter for plant and machinery remote monitoring, operating time measurement on measurement on construction plant and machinery and auto-measurement of consumed heat or electricity quantity on construction plant and machinery, (12) surveillance video communication and the like, by which the machine application types may be non-limited. And, there are ongoing discussions on other machine application types.

According to properties of M2M devices, the M2M device may have low mobility or no mobility. If a prescribed M2M device has considerably low mobility or does not have mobility at all, it may mean that the corresponding M2M device is stationary in the long term. An M2M communication system may be able to simplify or optimize mobility related operations for a specific M2M application related to such an M2M device having a stationary location as an M2M device for secured access and surveillance, an M2M device for public safety, an M2M device for payment, an M2M device for remote maintenance and control, an M2M device for metering and the like.

In the following description, an embodiment of the present invention is explained with reference to a case of applying M2M communication to a wireless communication system (e.g., IEEE 802.16e/m), by which the present invention may be non-limited. And, an embodiment of the present invention is applicable to such a different wireless communication system as 3GPP LTE system and the like in the same manner.

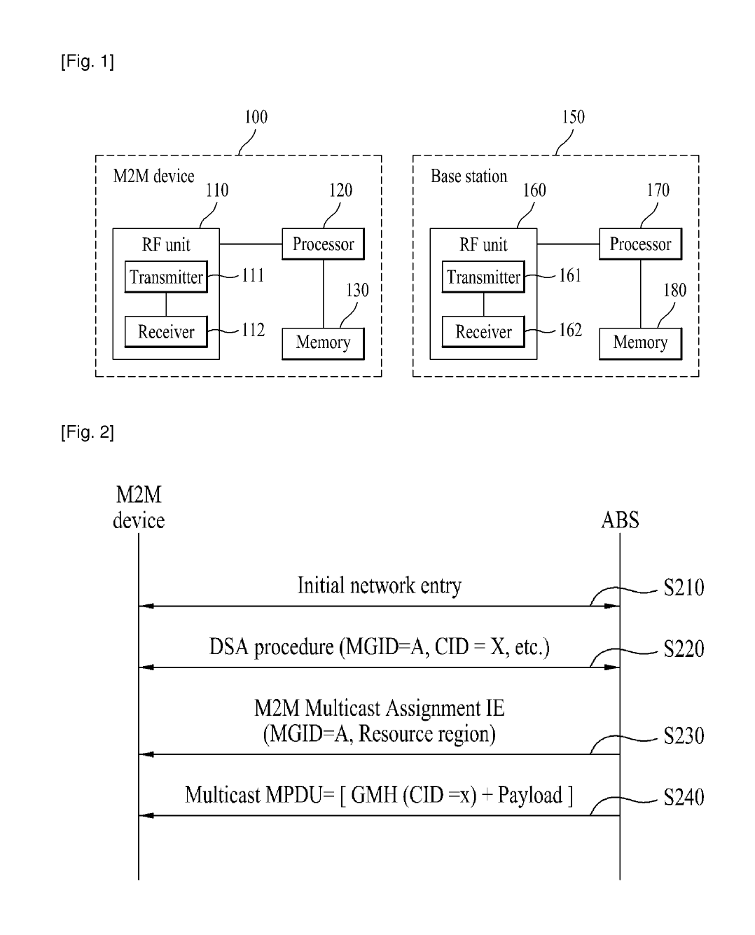

FIG. 1 is a schematic diagram for configurations of an M2M device and a base station according to one embodiment of the present invention.

Referring to FIG. 1, an M2M device 100, which may be named an M2M communication device but will be named as an M2M device in the following, may include an RF unit 110, a processor 120 and a memory 130. In this case, the memory 130 is an optional component. And, a base station 150 may include an RF unit 160, a processor 170 and a memory 180. In this case, the memory 180 is an optional component. The RF unit 110/160 may include a transmitter 111/161 and a receiver 112/162. For example of the M2M device 100, the transmitter 111 is configured to transmit signals to the base station 150 and other M2M devices. And, the receiver 112 is configured to receive signals from the base station 150 and other M2M devices. The process 120 performs various processings of a signal to transmit and then transfers the processed signal to the transmitter 111. And, the processor 120 may process a signal received by the receiver 112. If necessary, the processor 120 may control information contained in an exchanged message to be saved in the memory 130. The above-configured M2M device 100 may perform various methods according to embodiments of the present invention mentioned in the following description.

Besides, the M2M device 100 may further include various kinds of additional components (not shown in FIG. 1) according to its machine application type. In case that the corresponding M2M device 100 is provided for the smart meter, it may further include an additional configuration for power measurement and the like. This power measuring operation may be under the control of the processor 120 shown in FIG. 1 or a separately configured processor (not shown in the drawing).

Although FIG. 1 shows a case that a communication is performed between the M2M device 100 and the base station 150 for example, an M2M communication method according to the present invention may be performed between M2M devices. In particular, each of the M2M devices may have the same device configurations shown in FIG. 1 to perform various methods according to embodiments of the present invention mentioned in the following description.

The transmitter 161 of the base station 150 is configured to transmit signals to another base station, an M2M server and M2M devices. And, the receiver 162 of the base station 150 is configured to receive signals from another base station, an M2M server and M2M devices. The process 170 is functionally connected to each of the transmitter 161 and the receiver 162 to control a process for the transmitter 161 and the receiver 162 to transceive signals with other devices. The processor 170 performs various kinds of processings on a signal to transmit and then transfers the processed signal to the transmitter 161. And, the processor 170 may be able to perform processing on a signal received by the receiver 162. If necessary, the processor 170 may control information contained in an exchanged message to be saved in the memory 180. The above-configured base station 150 may perform various methods according to embodiments of the present invention mentioned in the following description.

The processor 120 of the M2M device 100 directs operations (e.g., control, adjustment, management, etc.) in the M2M device 100. The processor 170 of the base station directs operations (e.g., control, adjustment, management, etc.) in the base station 150. The processor 120/170 may be connected to the memory 130/180 configured to store program codes and data. The memory 130/180 is connected to the processor 120/170 to store operating systems, applications and general files.

The processor 120/170 may be named one of a controller, a microcontroller, a micro-processor, a microcomputer and the like. Moreover, the processor 120/170 may be implemented by hardware, firmware, software or a combination thereof. In case of implementing an embodiment of the present invention using hardware, the processor 120/170 may be provided with such a configuration to perform the present invention as ASICs (application specific integrated circuits), DSPs (digital signal processors), DSPDs (digital signal processing devices), PLDs (programmable logic devices), FPGAs (field programmable gate arrays), and the like.

In case of implementing embodiments of the present invention using firmware or software, the firmware or software may be configured to include modules, procedures, and/or functions for performing the functions or operations of the present invention. And, the firmware or software configured to perform the present invention may be driven by the processor 120/170 in a manner of being installed at the processor 120/170 or being saved in the memory 130/180.

In the following description, a multicast operation of an M2M application in IEEE 802.16p system is schematically explained. In IEEE 802.16p system, a multicast operation for M2M devices is supported. In particular, M2M multicast operation in idle mode is supported.

A base station may be able to provide a multicast service for an M2M device in idle mode with or without a request for a network reentry of an M2M device. Before the base station transmits downlink multicast data, base station may be able to send a paging message containing a multicast traffic indication to the M2M device during a paging listening interval of the M2M device. If the M2M device receives the paging message indicating a multicast traffic reception without a network reentry in the paging listening interval, the M2M device may start to receive the DL multicast data without ending the idle mode.

A multicast transmission start time TLV may be contained in the paging message to indicate a timing point of transmitting the downlink multicast data from the base station. A value of the multicast transmission start time TLV is smaller than a start time of a next paging listening interval for M2M device which receives a paging message (e.g., MOB PAG-ADV message). And, the M2M device may be able to power down until a frame indicated by the multicast transmission start time TLV in the MOB PAG-ADV message.

M2M group ID (hereinafter abbreviated MGID) is able to uniquely identify an M2M group in a region of a network entity of assigning MGID having at least one M2M device belong thereto. And, this MGID is used to identify a group of a device. For instance, this MGID may be used for a group paging. The MGID is assigned to an M2M device in case of an initial network entry or an explicit network emergency (exit) (e.g., a power-down location update). Unless the M2M device exits a corresponding network, the assigned MGID may be maintained by the M2M device despite that the M2M device is in idle mode. Moreover, the MGID may be reassigned. In a connected mode, MGID may be added or changed through a DSA or DSC process.

Table 1 shows 16-bit CID range defined in 802.16-2009.

TABLE 1

| CID | Value | Description |
|---|---|---|
| Ranging CID | 0x0000 | Used by SS and BS during ranging process. |
| Basic | 0x0001-m | The same value is assigned to both the DL and UL |
| | | connection. |
| Primary Management | m + 1-2m | The same value is assigned to both the DL and UL |
| | | connection. |
| Transport: | 2m + 1-0xFE9F | For the secondary management connection, the same value |
| Secondary Management | | is assigned to both the DL and UL connection. |
| Multicast CIDs | 0xFEA0-0xFEFE | For the DL multicast service, the same value is assigned to |
| | | all MSs on the same channel that participate in this |
| | | connection. |
| AAS Initial Ranging | 0xFEFF | A BS supporting AAS shall use this CID when allocating |
| | | an AAS ranging period (using AAS Ranging Allocation |
| | | IE). |
| Multicast Polling | 0xFF00-0xFFF9 | A MS may be included in one or more multicast polling |
| | | groups for the purpose of obtaining bandwidth via polling. |
| | | These connections have no associated service flow. |
| Normal Mode Multicast | 0xFFFA | Used in DL-MAP to denote bursts for transmission of DL |
| | | broadcast information to normal mode MS. |
| Sleep Mode Multicast | 0xFFFB | Used in DL-MAP to denote bursts for transmission of DL |
| | | broadcast information to sleep mode MS. May also be used |
| | | in MOB_TRF-IND messages. |
| Idle Mode Multicast | 0xFFFC | Used in DL-MAP to denote bursts for transmission of DL |
| | | broadcast information to idle mode MS. May also be used |
| | | in MOB_PAG-ADV messages. |
| Fragmentable Broadcast | 0xFFFD | Used by the BS for transmission of management broadcast |
| | | information with fragmentation. The fragment subheader |
| | | shall use 11-bit FSN on this connection. |
| Padding | 0xFFFF | Used for transmission of padding information by SS and |
| | | BS. |
| Broadcast | 0xFFFF | Used for broadcast information that is transmitted on a DL |
| | | to all SS. |

In the following description, M2M multicast operation based on IEEE 802.16m system is explained. First of all, a base station is able to establish a downlink (hereinafter abbreviated DL) multicast service by creating a multicast connection with each M2M device associated with a service. A randomly usable FID (flow identifier) may be usable for a multicast service (i.e., there are not dedicated FIDs for multicast transmission connection). The multicast connection may be settable using a combination of MGID and FID assigned through AAI-DSA MAC control. Since the multicast connection is associated with a service flow, it may be associated with QoS and traffic parameters of the service flow. For the multicast connection, ARQ may be applicable. Yet, a common security key may be user to provide integrity protection for encryption and multicast traffic.

Contents for the multicast connection setup are schematically described as follows. First of all, when an M2M device is registered to receive a multicast service, a serving base station (S-ABS) or the M2M device may be able to initiate a DSA procedure for multicast connection. A multicast service registration with a base station and a discovery of M2M devices via higher layer signaling are out of a range of this standard. AA-DSC procedures are used to change a multicast service flow. AAI-DSD procedure may be used to delete a multicast service flow for M2M device. And, multicast service flows of M2M device may be deleted when the M2M device moves away from a network or enters DCR mode. The M2M device should maintain a multicast service associated with service flow information in idle mode. A base station sends AAI-DSA-REQ/RSP message containing related multicast parameters including MGID to the M2M device.

An M2M multicast operation in idle mode is described as follows. First of all, a base station may be able to provide a multicast service for an M2M device in idle mode with or without a request for a network reentry of an M2M device. Before the base station transmits downlink multicast data, the base station may be able to transmit a paging message containing a multicast traffic indication to the M2M device during a paging listening interval of the M2M device. If the M2M device receives the paging message indicating a multicast traffic reception without a network reentry during the paging listening interval, it may start to receive the DL multicast data without ending the idle mode.

A multicast transmission start time TLV may be contained in the paging message to indicate a timing point of transmitting the downlink multicast data from the base station. A value of the multicast transmission start time TLV is smaller than a start time of a next paging listening interval of M2M device which receives a paging message (e.g., AAI-PAG-ADV message). And, the M2M device may be able to power down until a frame indicated by the multicast transmission start time TLV in the AAI-PAG-ADV message.

When the multicast data transmission is ended, the base station transmits AAI-MTE-IND message to notify the end of the multicast data transmission to the M2M device. If M2M device receive the AAI-MTE-IND message, the M2M device may be able to enter a paging unavailable interval. Table 2 shows on example of a paging message (e.g., AAI-PAG-ADV) that contains a multicast traffic indication and MGID for multicast paging.

TABLE 2

| Fields | Size | Value | Condition |
|---|---|---|---|
| For (i=0; | | Num_MGID indicates the number of | |
| i<Num_MGID; i++) { | | MGIDs included in this paging message | |
| | | [0 . . . 63] | |
| MGID | 12 | M2M Group ID | |
| Action Code | 2 | 0b00: Performing network reentry0b01: | |
| | | Performing location update0b10: Receiving | |
| | | multicast traffic without network | |
| | | reentry0b11: reserved | |
| If (Action code == | | | |
| 0b10) { | | | |
| Multicast transmission | 8 | Least Significant 8 bits of the frame number | Shall be |
| start time (MTST) | | in which the ABS starts sending DL | present |
| | | multicast data. | when the |
| | | | MTST |
| | | | needs to |
| | | | be |
| | | | included |
| | | | in this |
| | | | message |
| } | | | |
| } | | | |

Referring to Table 2, the AAI-PAG-ADV message may contain MGID field and Action Code field. In this case, if the Action Code is set to 0b10 to indicate that a multicast traffic will be received without a network reentry, the AAI-PAG-ADV message may be able to MTST (multicast transmission start time) field indicating least significant 8 bits of the frame number in which the base station (ABS) starts transmitting sending DL multicast data.

If the M2M device receives a paging message containing MGID assigned to the M2M device, the processor 120 of the M2M device controls the M2M device to be awake to receive multicast data during a paging unavailable interval and to receive a downlink channel.

A multicast service for M2M application is a traffic frequently occurred in such a specific situation as a firmware update and the like. In this case, if a resource for M2M multicast data is allocated using MBS-MAP IE defined for such a periodically generated traffic as a conventional real-time traffic, it may be inefficient. This is because, since an M2M device is not aware when its traffic will come, the M2M device may have a considerable overhead for the M2M device to keep decoding MAP IE in accordance with a transmission period of MBS-MAP IE.

Moreover, in the conventional IEEE 802.16e system, a primary/secondary management CID or a basic CID is assigned to an M2M device by a base station in case of network entry. And, a CID (connection identifier) for a service flow is assigned to an M2M device in case of a service generation (DSA procedure). If control information (e.g., MAP, etc.) is received, the processor 120 of the M2M device may be able to know whether the MAP corresponds to the M2M device 120 using the assigned CID. And, the processor 120 of the M2M device may be able to know whether MAC PDU (medium access control packet data unit) should be used by the processor 120 of the M2M device using the CID contained in MAC header.

This CID may be assigned to the M2M device in a CID range shown in Table 1. In the M2M multicast service, like the conventional multicast service (MBS), if a multicast service is identified in a manner that CID is contained in MAP IE using the CID assigned in the DSA procedure, the CID is not identified from a previous CID in a CID range. If a multicast CID is reused in the CID rage, since the number of multicast CIDs is limited to 95, it may not satisfy the total number of M2M multicast services sufficiently.

Therefore, necessary is a method of allocating a downlink resource to transmit M2M multicast data in IEEE 802.16e (wireless-MAN OFDMA (802.16-2009) system.

Table 3 shows one example of new extended DL MAP IE to transmit M2M multicast data.

TABLE 3

| Extended-3 DIUC (hexadecimal) | Usage |
|---|---|
| 0x0 | Power Boosting IE |
| 0x1 | M2M Multicast assignment IE |
| 0x2~0xF | Reserved |

Referring to Table 3, for example, a new extended DL MAP IE is set to 0x1 to indicate M2M multicast assignment IE.

Table 4 shows one example of M2M multicast assignment IE, format. A base station transmits M2M multicast assignment MAP IE, to indicate downlink assignment for transmitting M2M multicast data on downlink control information (e.g., DL-MAP).

TABLE 4

| Syntax | Size (bit) | Notes |
|---|---|---|
| M2M Multicast Assignment | — | — |
| IE( ){ | | |
| Extended-2 DIUC | 4 | M2M Multicast Assignment IE ( ) = 0xF |
| | | (Extended-3 DIUC) |
| Length | 8 | Length in bytes |
| Extended-3 DIUC | 4 | 0x01 |
| MGID | 15 | |
| DIUC | 4 | |
| OFDMA Symbol Offset | 8 | The offset of the OFDMA symbol |
| | | measuredin OFDMA symbols from |
| | | beginning of the DL frame in which the DL- |
| | | MAP istransmitted. Counting from the |
| | | framepreamble and starting from 0 |
| Subchannel offset | 7 | The offset of the first OFDMA symbol of the |
| | | MBS region measured in OFDMAsymbols |
| | | from beginning of this DL frame |
| No. Subchannels | 7 | |
| NO. OFDMA symbols | 7 | |
| Repetition Coding Indication | 2 | 0b00-No repetition coding0b01-Repetition |
| | | coding of 2 used0b10-Repetition coding of 4 |
| | | used0b11-Repetition coding of 6 used |
| if !(byte boundary) { | | |
| Padding Nibble | variable | Padding to reach byte boundary |
| } | | |
| } | — | — |

Referring to Table 4, M2M multicast Assignment IE (Information Element) may be transmitted using Extended-3 DIUC (when Extended-2 DIUC=15). Yet, it may be able to use a reserved DIUC in Extended DIUC instead of Extended-3 DIUC (downlink interval usage code). A base station may be able to transmit MGID contained in DSA instead of the CID assigned in the DSA procedure in a manner that the MGID is contained in MAP IE for multicast assignment.

Table 5 shows one example of M2M multicast Assignment IE using Extended DIUC (downlink interface usage code).

TABLE 5

| Extended DIUC (hexadecimal) | Usage |
|---|---|
| 0x0 | Channel Measurement IE |
| 0x5 | M2M multicast assignment IE |
| 0x6 | Reserved |

Referring to Table 5, a reserved 0x5 indicates M2M multicast assignment IE. A base station transmits M2M multicast assignment MAP IE to indicate downlink assignment for transmitting M2M multicast data on downlink control information (e.g., DL-MAP).

Table 6 shows one example of M2M Multicast Assignment IE format.

TABLE 6

| Syntax | Size (bit) | Notes |
|---|---|---|
| M2M Multicast Assignment | — | — |
| IE( ){ | | |
| Extended DIUC | 4 | M2M Multicast Assignment IE ( ) = 0x5 |
| Length | 4 | Length in bytes |
| MGID | 15 | |
| DIUC | 4 | |
| OFDMA Symbol Offset | 8 | The offset of the OFDMA symbol |
| | | measured in OFDMA symbols from |
| | | beginning of the DL frame in which the |
| | | DL-MAP is transmitted. Counting from |
| | | the frame preamble and starting from 0 |
| Subchannel offset | 7 | The offset of the first OFDMA symbol of |
| | | the MBS region measured in OFD- |
| | | MAsymbols from beginning of this DL |
| | | frame |
| No. Subchannels | 7 | |
| NO. OFDMA symbols | 7 | |
| Repetition Coding Indication | 2 | 0b00-No repetition |
| | | coding0b01-Repetition coding of 2 |
| | | used0b10-Repetition coding of 4 |
| | | used0b11-Repetition coding of 6 used |
| if !(byte boundary) { | | |
| Padding Nibble | variable | Padding to reach byte boundary |
| } | | |
| } | — | — |

Referring to Table 6, M2M Multicast Assignment IE message contains MGID instead of CID. And, the processor 120 of the M2M device may be able to know whether a burst corresponds to the M2M device by recognizing the MGID contained in the M2M Multicast Assignment IE. Thus, the burst received through the M2M Multicast Assignment IE contains MPDU (MAC protocol data unit). In this case, CID assigned in DSA instead of MGID may be contained in GMH (generic MAC header) of the MAC PDU.

FIG. 2 is a flowchart for one example of a process for assigning MGID (M2M group ID) and CID to an M2M device from a base station according to one embodiment of the present invention.

Referring to FIG. 2, an M2M device may be able to perform an initial network entry procedure with a base station [S210]. The M2M device may then receive assignment of MGID (A) and CID (X) for a multicast service flow from the base station [S220].

Thus, if service flow parameters are assigned to the M2M device, the M2M device may receive M2M Multicast Assignment A-MAP IE message, which may be named M2M Multicast Assignment IE message or the like, from the base station [S230]. In this case, the M2M Multicast Assignment A-MAP IE may be transmitted in a manner of being CRC (cyclic redundancy check) masked with MGID assigned to the M2M device.

The processor 120 of the M2M device determines whether the MGID (i.e., MGID=A) assigned to the M2M device is contained in the received M2M Multicast Assignment A-MAP IE. If the MGID is contained in the M2M Multicast Assignment A-MAP IE, the M2M device may be able to receive and decode a DL burst in accordance with instruction of the M2M Multicast Assignment A-MAP IE [S240]. In this case, the downlink burst may contain multicast MPDU (MAC protocol data unit). And, the CID assigned in the DSA may be contained in GMH (generic MAC header) of the multicast PDU instead of the MGID.

After the processor 120 of the M2M device decodes the downlink burst, if the CID in the multicast MPUD has the CID connected to the MGID contained in the M2M Multicast Assignment IE, the M2M device sends a corresponding multicast MPDU (MAC service data unit) to a higher layer. If there is no CID connected to the MGID, the M2M device may discard the corresponding multicast MPDU (MAC protocol data unit).

When the MGID is assigned in the DSA procedure of the step S210, an associated CID may be assigned in a manner of randomly selecting a prescribed one in a previous 16-bit CID range. In particular, the associated CID in such a region as basic CID, transport CID, multicast CID and the like in the previous CID range may be assigned to a mobile station. Alternatively, the associated CID may be assigned in a manner of overlapping with CIDs assigned to a unicast/multicast service flow.

Moreover, when MGID is connected with one service flow, if the MGID directly indicates the corresponding service flow, it may be unnecessary to use several CIDs for one MGID. In particular, one CID is used for all MGIDs, which is assigned in the DSA procedure. In doing so, one of multicast CIDs may be used as the CID. Since one of the multicast CIDs is used, the conventional MBS service is not affected.

If one MGID identifies one multicast service flow, it may be unnecessary for CID to be used for one MGID in identifying the multicast service flow. In particular, it may be just necessary to use one CID. In more particular, the MGID identifies a multicast service flow and the CID may confirm that a corresponding MPDU is M2M multicast data. The same CID may be used for all MGIDs. The corresponding CID may be assigned by a base station in DSA procedure or one CID reserved on system may be used as the corresponding CID. In case that one CID is determined on system, one multicast CID among CIDs shown in Table 1 may be reserved. For instance, 0xFEA0 or FEFE may be reserved as M2M multicast CID. If one CID is assigned in the DSA procedure, the base station may be able to assign one of the multicast CIDs as M2M multicast CID. If one CID is assigned in the DSA procedure, the base station may assign the same CID for all MGIDs.

The above-described CID assignment may similarly apply to IEEE 802.16m system. In particular, MGID is used to identify a multicast service flow. And, one FID (flow identifier) may be used to identify an M2M multicast burst. Meanwhile, the corresponding FID may be transmitted in a manner of being contained in MAC header of MAC PDU in M2M multicast burst. In this case, the corresponding FID may be assigned by a base station in the course of the DSA procedure or used in a manner of being reserved on system.

The M2M device, to which multicast service flow parameters are assigned, may be able to receive M2M Multicast Assignment A-MAP IE from the base station. And, the M2M Multicast Assignment A-MAP IE may be transmitted in a manner of being CRC (cyclic redundancy check) masked with the MGID assigned to the M2M device. The processor 120 of the M2M device determines whether the MGID assigned to the M2M device is contained in the received M2M Multicast Assignment A-MAP IE. If the assigned MGID is contained in the received M2M Multicast Assignment A-MAP IE, the M2M device may be able to receive and decode a DL burst in accordance with instruction of the received M2M Multicast Assignment A-MAP IE.

If a corresponding FID for identifying M2M multicast burst is assigned in the DSA procedure, a base station will assign the same FID to all multicast service flows (i.e., all MGIDs). Meanwhile, if one FID is stationarily used on system, a value of the FID may be set to a specific FID value (e.g., 0b0000, 0b1111, 0b0100, etc.) in 4-bit FID range (e.g., 0b0000˜0b1111). Thus, if one FIGD value is fixed for a multicast service flow in a system, it may be unnecessary to assign FID in a DSA procedure. In particular, MGID and a fixed FID may be transmitted in a manner of being contained in MAP IE and AGMH (advanced generic MAC header) (MAC header), respectively.

Therefore, the M2M device receives a downlink burst from the base station and the processor 120 of the M2M device may be able to decode an FID field in MAC header of MPDU (MAC PDU) carrying MSDU (MAC SDU) in the downlink burst. If the FID field in the MAC header of the MPDU is set to a promised specific FID value (e.g., 0b0000, 0b1111, 0b0100, etc.), the processor 120 of the M2M device may be able to know that this downlink burst is a multicast burst for a multicast service flow. In particular, the FID field in the MAC header of the MPDU carrying the MSDU for the multicast service flow may be set to one of 0b0000, 0b1111 and 0b0100. These contents may be applicable to both an idle mode and a connected mode and may be applicable to a terminal as well as M2M device.

Meanwhile, FID may use the same value for all multicast service flows (e.g., all MGIDs) within M2M group zone. Neighboring zones may use different FIDs, respectively. In this case, an M2M device may be able to know that a corresponding MGID belongs to which zone using the FID. To this end, when a base station broadcasts an M2M group zone ID list to M2M devices within a base station area to indicate an M2M group zone ID supported by the base station, the base station may be able to transmit M2M group zone ID and FID mapping information to the M2M devices.

In particular, the base station may be able to transmit the M2M group zone ID and the FID mapping information to the M2M devices in a manner that the M2M group zone ID and the FID mapping information are contained in AAI-SCD (system configuration descriptor) message in IEEE 802.16m system or DCD (downlink channel descriptor) message in IEEE 802.16e system. Regarding this FID information, a group paging information for notifying a multicast traffic reception to M2M devices in idle mode is contained a paging message together with MGID or may be contained in MAC header of multicast MPDU.

After the M2M device has received the multicast MPDU, the processor 120 of the M2M device checks an FID field of the MAC header and may be then able to confirm the multicast burst for its zone. If the FID has no relation or linkage with the assigned MGID, the M2M device may discard the received multicast data.

Table 7 shows one example of AAI-SCD message format. And, Table 8 shows one example of AAI-PAG-ADV message format.

TABLE 7

| | | | |
|---|---|---|---|
| | Size | | |
| Name | (bit) | Notes/Descriptions | Condition |

| | | |
|---|---|---|
| For (i=0; | | Number of M2M Group Zone |
| i<Num_MGZID; i++) | | IDs |
| { | | |
| MGZID | 8 | M2M Group Zone IDs |
| FID | 4 | Flow ID associated mapped |
| | | to M2M Group Zone ID |
| } | | |

Referring to Table 7, AAI-SCD message may contain an MGID field indicating an M2M group zone ID and an FID field indicating a flow ID associated by being mapped to the M2M group zone ID. The processor 120 of the M2M device checks the M2M group zone ID and the FID associated with the M2M group zone ID contained in the AAI-SCD message and may be then able to determine whether it is the multicast burst for its zone. If the FID has no relation or linkage with the assigned MGID, the M2M device may discard the received multicast data.

TABLE 8

| | | | |
|---|---|---|---|
| | Size | | Con- |
| Name | (bit) | Notes/Descriptions | dition |

| | | |
|---|---|---|
| For (i=0; i<Num_MGID; | | |
| i++) { | | |
| MGID | 8 | M2M Group Zone ID |
| FID | 4 | Flow ID associated mapped |
| | | to M2M Group Zone ID |
| Action code | 2 | 0b00: Network entry0b01: |
| | | location update0b10: |
| | | Receiving the multicast |
| | | traffic without network |
| | | reentry0b11: MGID |
| | | reassignment |
| If (Action code == 0b00) | | |
| { | | |
| } | | |

Referring to Table 8, AAI-PAG-ADV message may contain an MGID field indicating an M2M group zone ID and an FID field indicating a flow ID associated by being mapped to the M2M group zone ID. The processor 120 of the M2M device checks the M2M group zone ID and the FID associated with the M2M group zone ID contained in the AAI-PAG-ADV message and may be then able to determine whether it is the multicast burst for its zone. If the FID has no relation or linkage with the assigned MGID, the M2M device may discard the received multicast data.

In IEEE 802.16e system, one CID may be mapped to a specific M2M group zone ID in a manner similar to the above described manner. M2M group zones neighboring to each other may not use the same CID. Yet, the same CID may be usable for zones situated remote from each other. And, a corresponding CID may be assigned to a multicast CID region or a transport CID region.

MGID is delivered in a manner of being inserted in MAP IE and CID is delivered in a manner of being contained in MAC header. If a CID in a MAC header of multicast PDU does not coincide with a CID associated with CID assigned MGID, the processor 120 of the M2M device may delete the corresponding multicast MAC PDU.

Table 9 shows one example of a paging message (e.g., AAI-PAG-ADV message) that contains a multicast traffic indication and MGID for a multicast paging.

TABLE 9

| Fields | Size | Value | Condition |
|---|---|---|---|
| For (i=0; | | Num_MGID indicates the | |
| i<Num_MGID; i++) | | number of MGIDs included in | |
| { | | this paging message [0 . . . 63] | |
| MGID | 12 | M2M Group ID | |
| Action Code | 2 | 0b00: Performing network | |
| | | reentry0b01: Performing | |
| | | location update0b10: Receiving | |
| | | multicast traffic without | |
| | | network reentry0b11: reserved | |
| If (Action code == | | | |
| 0b10) { | | | |
| Multicast | 8 | Least Significant 8 bits of the | Shall be present when |
| transmission start | | frame number in which the | the MTST needs to be |
| time (MTST) | | ABS starts sending DL | included in this |
| | | multicast data. | message |
| } | | | |
| } | | | |

Referring to Table 9, if an AAI-PAG-ADV message contains an MGID and an action code field (i.e., Action code=0b10) indicating to receive a multicast traffic without network reentry, the AAI-PAG-ADV message may be able to further contain an MTST field indicating a multicast transmission start time. In this case, the MTST field indicates the multicast transmission start time by indicating 8 bits of LSB of the frame number in which the base station starts transmitting downlink multicast data.

If the M2M device receives a paging message containing MGID assigned to the M2M device, the M2M device receives a downlink channel by being awake during a paging unavailable interval to receive M2M device multicast data.

When a base station assigns an MGID for an M2M multicast service flow to one M2M device, the base station may be able to send a DSA message, in which FID and related service flow parameters are contained, to the corresponding M2M device. In this case, the MGID may indicate a multicast service flow by being combined with the FID.

If an MGID is contained in a paging message only, as currently defined in the IEEE 802.16 standard (802.16.1b/D1), the processor 120 of the M2M device should be controlled to be awake in order to check whether it is multicast data of the M2M device even if an FID not assigned to the M2M device for the MGID assigned to the M2M device is paged. For instance, when one M2M device has connection with a multicast service flow set to ‘MGID=1’ and ‘FID=1’, if a base station performs a group paging on a multicast service flow set to ‘MGID=1’ and ‘FID not equal to 1’, since ‘MGID=1’ is transmitted by being contained in a paging message, the M2M device should be eventually awaken from an idle mode to receive a multicast paging and wait to receive multicast data corresponding to the M2M device. This requires an unnecessary operation performed by the M2M device, thereby increasing power consumption of the M2M device.

In order to solve such a problem as a power consumption increase and the like, when a base station performs a group paging for a multicast data transmission, the base station may need to send a paging message to an M2M device in a manner that FID is contained in the paging message as well as MGID. When the M2M device receives a group paging message for a multicast data reception, the processor 120 of the M2M device checks whether the MGID and FID contained in the paging message correspond to the MGID and FID assigned to the M2M device. If a corresponding value is present, the processor 120 of the M2M device does not perform the network reentry and may control the M2M device to be awake to receive multicast data.

Table 10 shows one example of AAI-PAG-ADV message format containing FID.

TABLE 10

| | Size | | |
|---|---|---|---|
| Fields | (Bit) | Value | Condition |
| For (i=0; | | Num_MGID indicates the | |
| i<Num_MGID; i++) | | number of MGIDs included in | |
| { | | this paging message [0 . . . 63] | |
| MGID | 12 | M2M Group ID | |
| Action Code | 2 | 0b00: Performing network | |
| | | reentry0b01: Performing | |
| | | location update0b10: | |
| | | Receiving multicast traffic | |
| | | without network reentry0b11: | |
| | | reserved | |
| If (Action code == | | | |
| 0b10) { | | | |
| FID | 4 | Flow ID associated with | |
| | | MGID for a multicast service | |
| | | flow | |
| Multicast | 8 | Least Significant 8 bits of the | Shall be present when |
| transmission start | | frame number in which the | the MTST needs to be |
| time (MTST) | | ABS starts ending DL | included in this |
| | | multicast data. | message |
| } | | | |
| } | | | |

Referring to Table 10, an AAI-PAG-ADV message may contain an MGID field indicating an M2M group ID and an action code field. In this case, if the action code field indicates to receive a multicast traffic without a network reentry (i.e., Action code=0b10), the AAI-PAG-ADV message may further contain an FID field indicating a flow ID associated with an MGID for a multicast service flow and a multicast transmission start time (MTST) field. In particular, in case of a group paging for transmitting a multicast traffic, a base station may enable an associated FID information to be contained in a paging message.

If the MGID corresponds to the M2M device and the action code field indicates to receive the multicast traffic without the network reentry, the processor 120 of the M2M device may be able to decode the FID field. The processor 120 of the M2M device checks whether the decoded FID corresponds to the FID assigned to the M2M device. If a corresponding value is present, the processor 120 of the M2M device does not perform the network reentry and may control the M2M device to be awake to receive multicast data.

Table 11 shows another example of AAI-PAG-ADV message format containing FID.

TABLE 11

| | Size | | |
|---|---|---|---|
| Fields | (bits) | Value | Condition |
| For (i=0; i < | | Num_MGID indicates the | |
| Num_MGID; i++) { | | number of MGIDs included | |
| | | in this paging message [0 . . . 63] | |
| MGID | 12 | M2M Group ID | |
| FID | 4 | Flow ID associated with | |
| | | MGID for a multicast service | |
| | | flow | |
| Action code | 2 | 0b00: Performing network | |
| | | reentry0b01: Performing | |
| | | location update0b10: | |
| | | Receiving multicast traffic | |
| | | without network reentry0b11: | |
| | | reserved | |
| If (Action code == | | | |
| 0b10) { | | | |
| Multicast | 8 | Least significant 8 bits of the | Shall be present when |
| transmission start | | frame number in which the | the MTST needs to be |
| time (MTST) | | ABS starts sending DL | included in this |
| | | multicast data | message |
| } | | | |
| } | | | |

Referring to Table 11, an AAI-PAG-ADV message nay contain an MGID for a multicast service follow and an FID field indicating an associated flow ID for all group pagings irrespective of an action code. In this case, it is advantageous in that an M2M device performing a network reentry as a group or an M2M device performing a group location update does not perform an unnecessary operation on an FID not assigned to the corresponding M2M device.

According to the above-described embodiments of the present invention, a base station efficiently transmits multicast data to M2M devices, thereby enhancing communication performance in aspect of the M2M devices.

The operation of an M2M device according to the present invention may be performed by a mobile station or terminal as long as it is not the unique operation of the M2M device. And, field names (or parameter names) described in each message format may be called different names of other types. Although the content of the present invention are mainly described with reference to IEEE 802.16, they may be applicable to operations of MTC devices of 3GPP LTE-A system.

The above-described embodiments correspond to combinations of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

A method of receiving multicast data by an M2M (machine-to-machine) device is industrially applied to wireless communication system such as 3GPP LTE, LTE-A, IEEE 802 and like that.

1. A method of receiving multicast data by an M2M (machine-to-machine) device in a wireless communication system, the method comprising:
receiving, information including an M2M group identifier (MGID) assigned to the M2M device, from a base station;
receiving, a message related to M2M multicast assignment including the MGID, from the base station; and
receiving the multicast data based on the message from the base station, wherein the multicast data comprises a flow identifier (FID) field in a MAC header of a MAC PDU (medium access control packet data unit) for a multicast service flow, and
wherein the FID field is set to a specific value.

2. The method of claim 1, wherein the specific value set for the FID field is set to 0b0100 or 0100.

3. The method of claim 1, wherein the message is a M2M multicast assignment A-MAP IE (Information Element) message.

4. The method of claim 3, wherein the MGID is transmitted through the M2M multicast assignment IE by a manner that the MGID is CRC (cyclic redundancy check) masked.

5. A method of transmitting multicast data at a base station in a wireless communication system, the method comprising:
transmitting, information including an assigned M2M group identifier (MGID), to an M2M (machine-to-machine) device;
transmitting, a message related to M2M multicast assignment including the MGID, to the M2M device; and
transmitting the multicast data to the M2M device based on the message,
wherein the multicast data comprises a flow identifier (FID) field in a MAC header of a MAC PDU (medium access control packet data unit) for a multicast service flow, and
wherein the FID field is set to a specific value.

6. The method of claim 5, wherein the specific value set for the FID field is set to 0b0100 or 0100.

7. An M2M (machine-to-machine) device for receiving multicast data in a wireless communication system, the M2M device comprising:
a receiver configured to receive information including an M2M group identifier (MGID) assigned to the M2M device, a message related to M2M multicast assignment including the MGID, and downlink data based on the message from a base station; and
a processor configured to determining the received downlink data as the multicast data if the downlink data comprises a flow identifier (FID) field in a MAC header of a MAC PDU (medium access control packet data unit) for a multicast service flow and the FID field is set to a specific value.

8. The M2M device of claim 7, wherein the specific value set for the FID field is set to one of 0b0100 and 0100.

9. The M2M device of claim 7, wherein the message is a M2M multicast assignment A-MAP IE (Information Element) message.

10. A base station for transmitting multicast data in a wireless communication system, the base station comprising:
a transmitter configured to transmit information including an M2M group identifier (MGID) assigned to an M2M (machine-to-machine) device, a message related to M2M multicast assignment including the MGID, and the multicast data based on the message to the M2M device,
wherein the multicast data comprises a flow identifier (FID) field in a MAC header of a MAC PDU (medium access control packet data unit) for a multicast service flow, and
wherein the FID field is set to a specific value.

11. The base station of claim 10, wherein the specific value set for the FID field is set to 0b0100 or 0100.
